(19) United States
(12) Patent Application Publication
(10) Pub. No.: US 2012/0050944 A1
(43) Pub. Date: Mar. 1, 2012

(54) Capacitor unit cell and energy storage module with the same

(75) Inventors: Young Hak Jeong, Gunpo-si (KR); Bae Kyun Kim, Seongnam-si (KR); Senug Hyun Ra, Seongnam-si (KR); Hyun Chul Jung, Yongin-si (KR); Yong Wook Kim, Suwon-si (KR)

(73) Assignee: SAMSUNG ELECTRO-MECHANICS CO., LTD., Suwon (KR)

(21) Appl. No.: 12/926,821

(22) Filed: Dec. 10, 2010

(30) Foreign Application Priority Data
Aug. 27, 2010 (KR) 10-2010-0083377

(51) Int. Cl. H01G 9/155

(52) U.S. Cl. 361/502

(57) ABSTRACT

Disclosed herein is an energy storage module. The energy storage module according to an embodiment of the present invention includes a plurality of capacitor unit cells each having a plus terminal and a minus terminal; and a connection part configured to electrically connect the plus terminal of any one of the capacitor unit cells to the minus terminal of another capacitor unit cell, wherein each of the capacitor unit cells includes an outer case housing an energy storage element, and wherein the outer case includes a protrusion part protruded from one surface of the outer case; and a depression part having a shape matched with the protrusion part and recessed from another surface of the outer case toward inside of the outer case.

### CROSS REFERENCE TO RELATED APPLICATION

This application claims the benefit under 35 U.S.C. Section [120, 119, 119(e)] of Korean Patent Application Serial No. 10-2010-0083377, entitled “Capacitor Unit Cell and Energy Storage Module With The Same”, filed on Aug. 27, 2010, which is hereby incorporated by reference in its entirety into this application.

### BACKGROUND OF THE INVENTION

1. Technical Field

The present invention relates to a capacitor unit cell and an energy storage module with the same, and more particularly, to a capacitor unit cell with improved integration degree and assemblability, and an energy storage module with the same.

2. Description of the Related Art

Devices, which are referred to as ultracapacitors or supercapacitors that are the next-generation energy storage devices have become the main focus due to a rapid charging/discharging speed, high stability and echo-friendly characteristics.

Such an energy storage device can be used as an energy storage module by modularizing a plurality of unit cells that implement high output and high capacitance. For example, vehicles, such as cars, can be equipped with the energy storage module, such as a supercapacitor, as an auxiliary power supply, and the energy storage mode has the structure of a capacitor cell array consisting of the plurality of capacitor unit cells.

However, each of the general capacitor unit cells has the shape of a hexahedron or a cylinder. Therefore, in order for modularization, separate fixing means needs to be included for fixing and assembling the capacitor unit cells, and additional elements are required for their electrical connection and assembly. However, in the case where the capacitor unit cells are fixed and assembled using separate fixing means and additional elements, the entire structure of the energy storage module becomes complicated and the assemblability and separability of the capacitor cell array is reduced.

Furthermore, in the case where capacitor unit cells having the shape of a hexahedron or a cylinder as described above are arranged in a plane, the entire size of the energy storage module increases due to the occupied areas of the capacitor unit cells and the fixing means and the additional elements. As a result, a general energy storage module has limitations in reducing its entire size due to additional configurations besides the capacitor unit cells.

### SUMMARY OF THE INVENTION

An object of the present invention is to provide a capacitor unit cell having improved integration degree and an energy storage module with the same.

Further, another object of the present invention is to provide a capacitor unit cell having improved facility for assembly and separation and an energy storage module with the same.

According to an exemplary embodiment of the present invention, there is provided a capacitor unit cell, including an energy storage element; and an outer case housing the energy storage element, wherein the outer case includes a protrusion part protruded from one surface of the outer case; and a depression part having a shape matched with the protrusion part and recessed from another surface of the outer case toward the inside of the outer case.

The protrusion part may be inserted into and fitted to a part of a capacitor unit cell different from the capacitor unit cell, the depression part may be inserted into and fitted to a part of a capacitor unit cell different from the capacitor unit cell.

The protrusion part and the depression part may have a shape of a pillar.

The outer case may include an upper side, a lower side opposite to the upper side and first to fourth sides coupling the upper side and the lower side, wherein the first side may be opposite to the third side, the second side may be opposite to the fourth side, the protrusion part may be provided to the first and second sides, and the depression part may be provided to the second and fourth sides.

The protrusion part includes a structure perpendicularly protruded from one side of the outer case in one direction; and an anti-releasing part protruded from the structure in a direction perpendicular to the one direction.

According to another exemplary embodiment of the present invention, there is provided an energy storage module, including: a plurality of capacitor unit cells each having a plus terminal and a minus terminal; and a connection part configured to electrically connect the plus terminal of any one cell of the capacitor unit cells to the minus terminal of another cell; wherein each of the capacitor unit cells includes an outer case housing an energy storage element, and wherein the outer case includes: a protrusion part protruded from one surface of the outer case; and a depression part having a shape matched with the protrusion part and recessed from another surface of the outer case toward the inside of the outer case.

The protrusion part of any one cell of the capacitor unit cells may be inserted into the depression part of another cell adjacent to the any one cell, and the protrusion part of the other cell adjacent to the any one cell may be inserted into the depression part of the any one cell.

The protrusion part of any one cell of the capacitor unit cells may be inserted into the depression part of another cell adjacent thereto, and the protrusion part is slidably contacted with and fitted to the depression part.

The protrusion part of any one cell of the capacitor unit cells may be inserted into the depression part of another cell adjacent thereto, and the protrusion part may be fitted to the depression part by press fit.

The protrusion part and the depression part may have a shape of a projection.

The outer case includes an upper side, a lower side opposite to the upper side and first to fourth sides coupling the upper side and the lower side, the first side may be opposite to the third side, the second side may be opposite to the fourth side, the protrusion part may be provided to the first and third sides, and the depression part may be provided to the second and fourth sides.

The protrusion part includes: a structure protruded from one side of the outer case in one direction; and an anti-releasing part protruded from the structure in a direction perpendicular to the one direction.

The protrusion part further includes an anti-releasing groove having a shape matched with that of the anti-releasing part.

### BRIEF DESCRIPTION OF THE DRAWINGS

FIG. 1 is a perspective view illustrating an energy storage module according to an embodiment of the present invention;

FIG. 2 is a perspective view illustrating one capacitor unit cell shown in FIG. 1;

FIG. 3 a perspective view illustrating an energy storage module according to a modification of the present invention;

FIG. 4 is a perspective view illustrating any one of the capacitor unit cells shown in FIG. 3;

FIG. 5 is a perspective view illustrating an energy storage module according to another modification of the present invention;

FIG. 6 is a perspective view illustrating any one of the capacitor unit cells shown in FIG. 5;

FIG. 7 is a perspective view illustrating an energy storage module according to still another modification of the present invention; and

FIG. 8 is a perspective view illustrating any one of the capacitor unit cells shown in FIG. 7.

### DESCRIPTION OF THE PREFERRED EMBODIMENTS

Advantages and characteristics of the present invention, and a method for achieving them will be apparent with reference to embodiments described below in addition to the accompanying drawings. However, the present invention is not limited to the embodiments disclosed below, but may be implemented in various forms. The embodiments may be provided to completely disclose the present invention and allow those skilled in the art to completely know the scope of the present invention. Throughout the specification, like elements refer to like reference numerals.

Terms used in the specification are used to explain the embodiments and not to limit the present invention. In the specification, a singular type may also be used as a plural type unless stated specifically. “Comprises” and/or “comprising” used the specification mentioned constituent members, steps, operations and/or elements do not exclude the existence or addition of one or more other components, steps, operations and/or elements.

Hereinafter, a capacitor unit cell and an energy storage module with the same according to the present invention will be described with reference to the accompanying drawings.

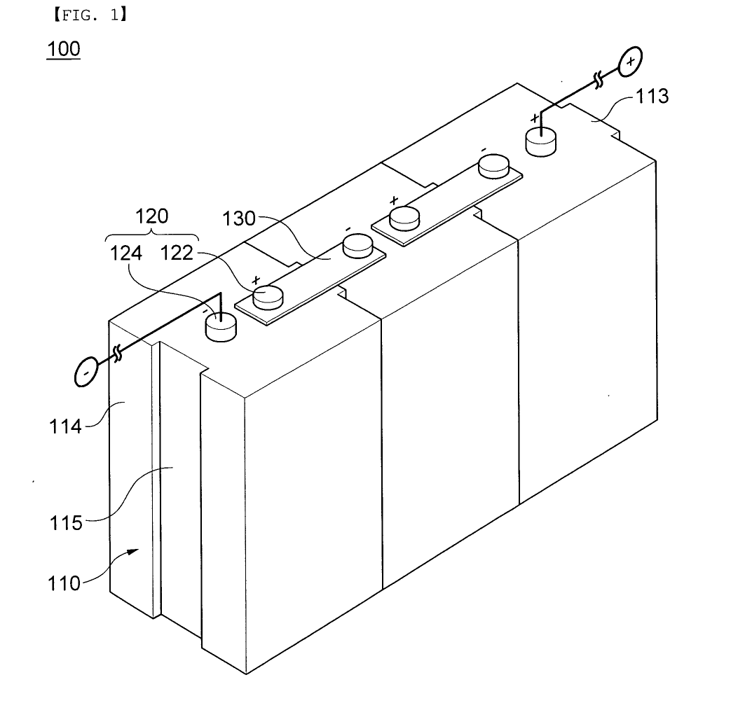

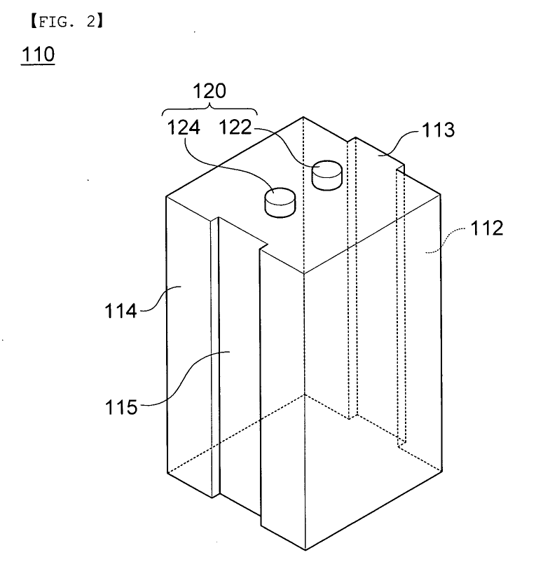

FIG. 1 is a perspective view illustrating an energy storage module according to an embodiment of the present invention, and FIG. 2 is a perspective view illustrating one capacitor unit cell shown in FIG. 1.

Referring to FIGS. 1 and 2, the energy storage module 100 according to an embodiment of the present invention may have a structure into which a plurality of capacitor unit cells 110 is combined. Each of the capacitor unit cells 110 may be an energy storage unit cell within which an energy storage element, which is referred to as an ultra-capacitor or a super-capacitor, is included. In this case, the energy storage module 100 may be a capacitor cell array consisting of a plurality of super-capacitors.

Each of the capacitor unit cells 110 may have an external electrode terminal 120 thereon. The external electrode terminal 120 may include a plus terminal 122 and a minus terminal 124 which are spaced from each other. The plus terminal 122 and the minus terminal 124 may be connected to the positive electrode (not shown) and negative electrode (not shown) of the energy storage element, respectively.

The capacitor unit cells 110 may be connected in series to each other via a connection element 130. The connection element 130 can electrically connect the plus terminal 122 of any one capacitor unit cell 110 of the capacitor unit cells 110 and the minus terminal 124 of another capacitor unit cell 110 adjacent to any one capacitor unit cell 110. For this, the connection element 130 can have a plate structure on which an insert hole, through which the plus terminal 122 and the minus terminal 124 are inserted, is formed.

Meanwhile, respective capacitor unit cells 110 may have substantially the same external structure. Furthermore, the capacitor unit cells 110 may be configured to be assembled and fixed to each other to implement the energy storage module 100.

For this, the outer case of each capacitor unit cell 110 may have a structure through which a part of another capacitor unit cell 110 adjacent thereto can be inserted. As an example, the outer case of each capacitor unit cell 110 has the shape of a hexahedron and the outer case can have an upper surface, a lower surface opposite to the upper surface and four sides which couple the upper surface and the lower surface and are form-fitted to the adjacent capacitor unit cell 110. The sides may include one side 112 contacted with another capacitor unit cell 110 and another side 114 contacted with the other capacitor unit cell 110. The one side 112 may be a surface opposite to another side 114.

In this case, a protrusion part 113 which is inserted into another capacitor unit cell 110 is formed on one side 112, and a depression part 115 into which a part of another capacitor unit 110 is inserted is formed on another side 114. The protrusion part 113 and the depression part 115 may be structured to have shapes matched with each other. For example, the protrusion part 113 provided in any one capacitor unit cell 110 may have a structure inserted into and fixed to the depression part 115 provided in another capacitor unit cell 110. In this case, the protrusion part 113 may be structured to be slidably surface-contacted with and fitted to the depression part 115. Alternatively, the protrusion part 113 is fitted to the depression part 115 by press fit.

The energy storage module 100 having the above-described structure may be fabricated in such a way that the protrusion parts 113 and depression parts 115 of the capacitor unit cells 110 are fitted to depression parts 115 and the protrusion parts 113 of other capacitor unit cells, respectively. In this case, the capacitor unit cells 110 are contacted and form-fitted to each other, so that the occupied area of the energy storage module 100 may be identical to the sum of the occupied areas of respective capacitor unit cells 110.

As described above, the energy storage module 100 according to the embodiment of the present invention has a capacitor cell array structure in which the plurality of capacitor unit cells 110 are combined with each other, and respective capacitor unit cells 110 may have a structure in which respective capacitor unit cells 110 are inserted into and fitted to other capacitor unit cells adjacent thereto. Accordingly, in the energy-storage module according to the present invention assembles the capacitor unit cells 110 without separate fixing means, so that capacitor cell arrays fixed to each other can be constructed to improve assemblability and separation easiness.

Furthermore, the energy storage module 100 according to the embodiment of the present invention has the capacitor cell array structure in which the plurality of capacitor unit cells 110 are combined with each other, and may have a structure in which respective capacitor unit cells 110 are contacted with and form-fitted to other capacitor unit cells 110 adjacent thereto. As a result, the occupied area of the energy storage module according to the present invention is identical to the sum of the occupied areas of the respective capacitor unit cells 110, so that integration degree can be dramatically improved, as compared to an energy storage module having separate fixing means and having a structure in which the capacitor unit cells are spaced from and assembled to each other.

A capacitor unit cell and an energy storage module with the same according to modifications of the present invention are described in detail below. In this case, details which have been already described with respect to the capacitor unit cell 110 and energy storage module 100 as described above are omitted and simplified.

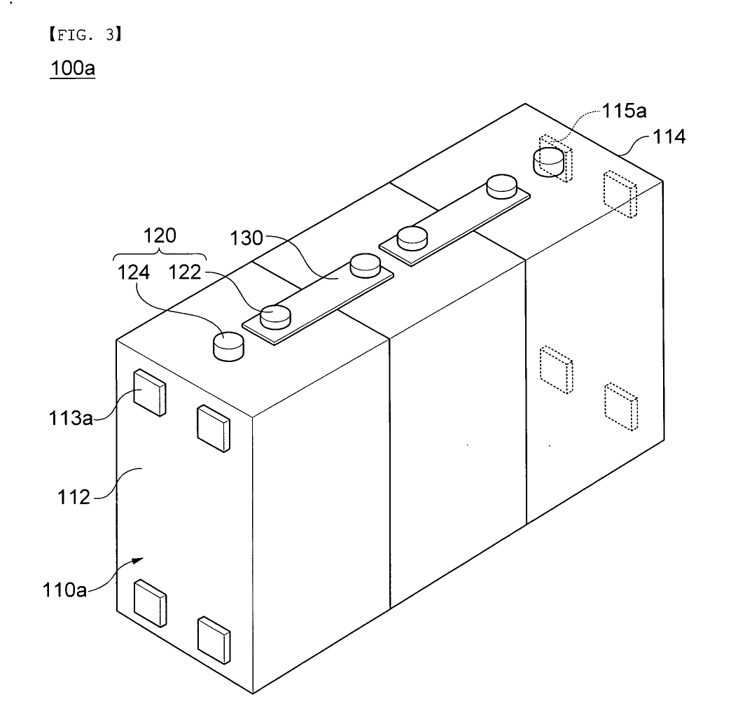

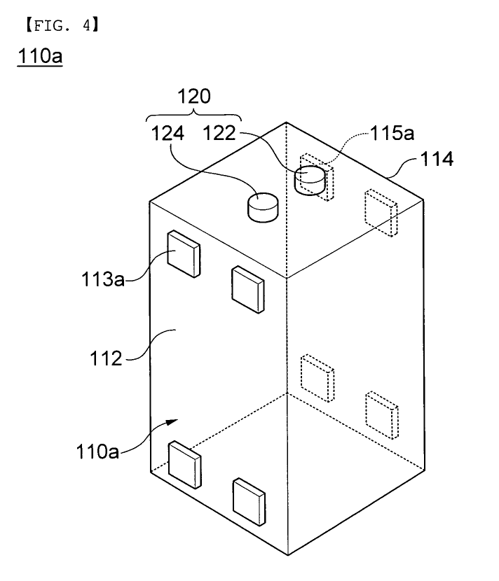

FIG. 3 is a perspective view illustrating an energy storage module according to a modification of the present invention, and FIG. 4 is a perspective view illustrating any one of the capacitor unit cells shown in FIG. 3.

Referring to FIGS. 3 and 4, the energy storage module 100a according to a modification may include capacitor unit cells 110a having a plurality of protrusion parts 113a and a plurality of depression parts 115a, unlike the energy storage module 100 as described above with respect to FIGS. 1 and 2. The protrusion parts 113a and the depression parts 115a may include the shape of the projection. As an example, the protrusion parts 113a may have the shape of a quadrangular pillar protruded from a side of the unit cells 110a. However, the shape of the protrusion parts 113a is not limited to this shape and various shapes are possible. As another example, the protrusion parts 113a may have the shape of a cylinder and a hexagonal pillar.

The protrusion parts 113a may have a shape matched with the depression parts 115a such that the depression parts 115a are fitted and fixed thereto. More particularly, the protrusion part 113a included in any one cell of the capacitor unit cells 110a may be inserted and fitted to the depression part 115a included in another cell. In addition, with respect to the depression part 115a included in any one cell of the capacitor unit cells 110a, the protrusion part 113a included in another cell may be inserted and fitted. Therefore, the capacitor unit cells 110a may have a structure in which the protrusion parts 113a and the depression parts 115a are fitted to and fixed to each other.

Meanwhile, an external electrode terminal 120 consisting of a plus terminal 122 and a minus terminal 124 may be included on the upper surface of the capacitor unit cells 110a. In this case, the plus terminal 122 of any one capacitor unit cell 110a may be electrically connected to the minus terminal 124 of another capacitor unit cell 110a by the connection element 130.

In the present embodiment, although the case of having the four protrusion parts 113a and the four depression parts 115a is exemplarily described, the number of protrusion parts 113a and depression parts 115a may vary.

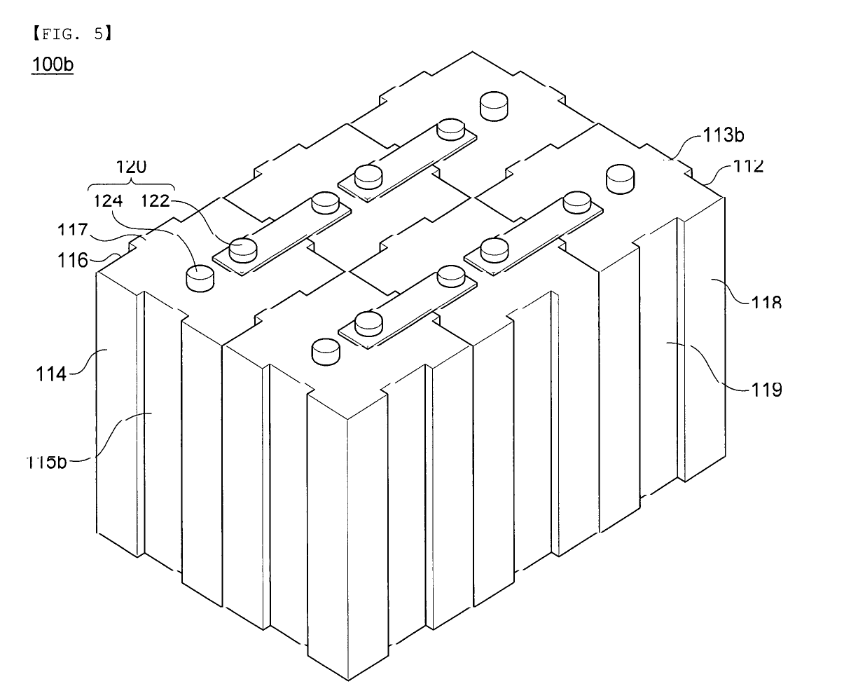

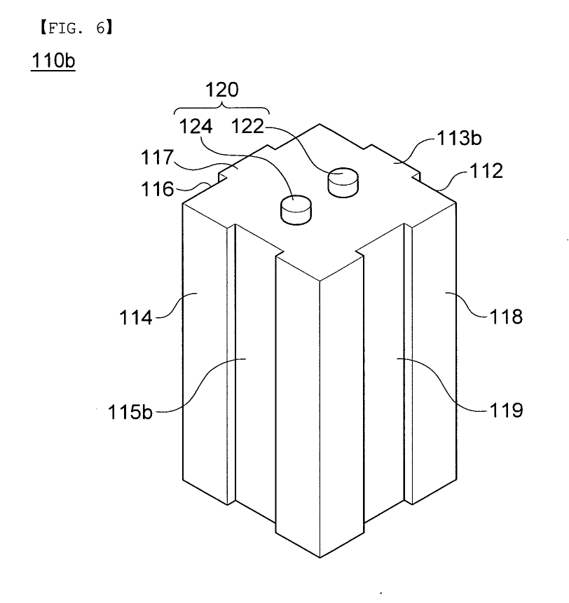

FIG. 5 is a perspective view illustrating an energy storage module according to another modification of the present invention, and FIG. 6 is a perspective view illustrating any one of the capacitor unit cells shown in FIG. 5.

Referring to FIGS. 5 and 6, the energy storage module 100b according to another modification of the present invention may include capacitor unit cells 110b having two protrusion parts and two depression parts unlike the energy storage module 100 as described above with respect to FIGS. 1 and 2.

More particularly, the outer case of the capacitor unit cells 110b has substantially the shape of a hexahedron and may have first to fourth sides 112, 114, 116 and 118. The first side 112 may be opposite to the second side 114 and the third side 116 may be opposite to the fourth side 118.

In this case, the protrusion parts may include a first protrusion part 113b included in the first side 112 and a second protrusion part 117 included in the third side 116. Furthermore, the depression parts may include a first depression part 115b included in the second side 114 and a second depression part 119 included in the fourth side 118.

Meanwhile, an external electrode terminal 120 consisting of a plus terminal 122 and a minus terminal 124 may be included on the upper surface of the capacitor unit cells 110b. In this case, the plus terminal 122 of any one capacitor unit cell 110 can be electrically connected to the minus terminal 124 of another capacitor unit cell 110b by the connection element 130.

The energy storage module 100b having the above-described structure may have a structure in which the capacitor unit cells 110b are structured to be all fitted to other capacitor cells 110b adjacent to their four sides unlike the energy storage module 100b shown in FIGS. 1 and 2. As a result, the energy storage module 110b according to another modification of the present invention is structured such that not only the capacitor unit cells 110b arranged in one direction are fitted to and fixed to each other, but also the capacitor unit cells 110b arranged in another direction perpendicular to the one direction are fitted to and fixed to each other, thereby acquiring the structure having not only improved assemblability and separability but also improved fixability and assembly strength in association with the capacitor unit cells 110b.

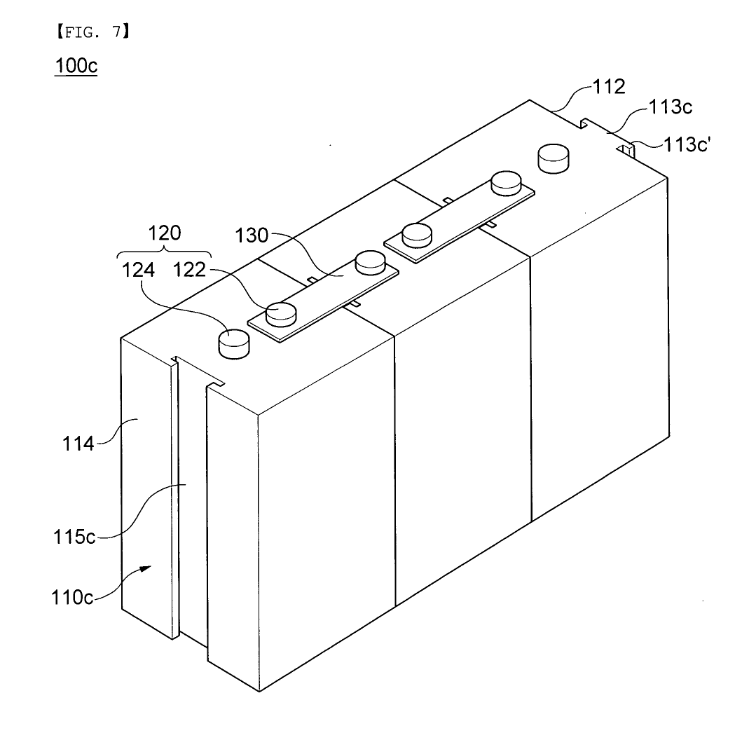

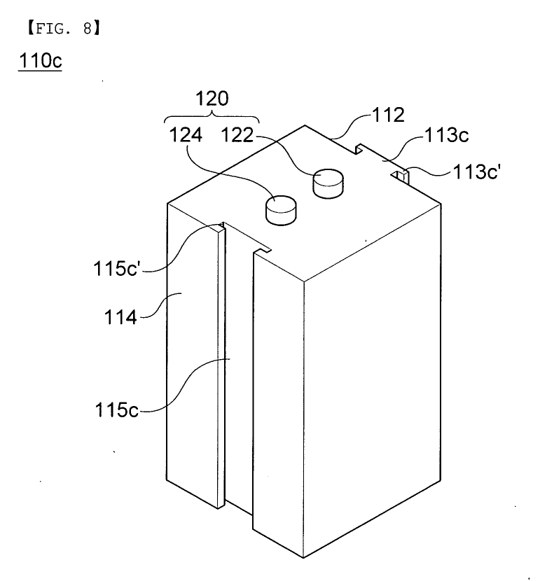

FIG. 7 is a perspective view illustrating an energy storage module according to still another modification of the present invention, and FIG. 8 is a perspective view illustrating any one of the capacitor unit cells shown in FIG. 7.

Referring to FIGS. 7 and 8, the energy storage module 100c may be composed of capacitor unit cells 110c each having a protrusion part 113c having an anti-releasing part 113′ and a depression part 115c having an anti-releasing groove 115′ unlike the energy storage module 100 as described above with respect to FIGS. 1 and 2.

More particularly, the protrusion parts 113, 113a and 113b and the depression parts 115, 115a and 115b as described above with respect to FIGS. 1 to 6 may have a structure protruded from a side of the capacitor unit cells only in one direction. In this case, when the energy storage module 100 are shocked, the protrusion parts 113, 113a and 113b and the depression parts 115, 115a and 115b are slidably surface-contacted with and coupled to each other, so that the capacitor unit cells may be separated from each other. In order to prevent separation, the protrusion part 113c and the depression part 115c may have a structure for preventing the capacitor unit cells 110c from being separated from each other in the direction of surfaces.

As an example, the protrusion part 113c has the structure protruded from one side 112 of the capacitor unit cell 110c in one direction, and may have the anti-releasing part 113c′ protruded from the protruded structure in a direction substantially perpendicular to the one direction. In this case, the anti-releasing part 113c′ may have a structure extended from end of the protruded structure. In this case, the cross section of the entire structure of the protrusion part 113c may substantially have the shape of a letter ‘T’. Meanwhile, the depression part 115c may be structured to have a shape matched with the protrusion part 113c having the above-described structure. As a result, the cross section of entire structure of the depression part 115c may substantially have the shape of the letter ‘T’.

Using protrusion part 113c and the depression part 115c having the shape of the above-described letter ‘T’, the energy storage module 100c can prevent the capacitor unit cells 110c from being separated from each other, thereby acquiring a structure resistant to external shock.

Meanwhile, an external electrode terminal 120 consisting of a plus terminal 122 and a minus terminal 124 may be included on the upper surface of the capacitor unit cells 110c. In this case, the plus terminal 122 of any one capacitor unit cell 110 can be electrically connected to the minus terminal 124 of another capacitor unit cell 110c by the connection element 130.

The capacitor unit cell can have a structure in which its partial part is fitted to another capacitor cell to allow assembly. Therefore, the capacitor unit cell of the present invention can be directly form-fitted to and assembled with another capacitor unit cell adjacent thereto upon configuration of a capacitor cell array, thereby increasing integrating degree and improving separability and separation easiness.

The energy storage module according to the present invention includes a capacitor cell array in which a plurality of capacitor unit cells are combined, and can have a structure in which respective capacitor unit cells are inserted into and fixed to other capacitor unit cells adjacent thereto. As a result, the energy storage module according to the present invention assembles the capacitor unit cells without separate fixing means, so that capacitor cell arrays fixed to each other can be constructed to improve assemblability and separation easiness.

Furthermore, the energy storage module according to the present invention includes a capacitor cell array in which a plurality of capacitor unit cells are combined, and can have a structure in which respective capacitor unit cells are form-fitted to and fixed to other capacitor unit cells adjacent thereto. As a result, the occupied area of the energy storage module according to the present invention is identical to the sum of the occupied areas of respective capacitor unit cells, thereby improving integration degree.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A capacitor unit cell, comprising:
an energy storage element; and
an outer case housing the energy storage element,
wherein the outer case includes:
a protrusion part protruded from one surface of the outer case; and
a depression part having a shape matched with the protrusion part and recessed from another surface of the outer case toward inside of the outer case.

2. The capacitor unit cell according to claim 1, wherein the protrusion part is inserted into and fitted to a part of a capacitor unit cell different from the capacitor unit cell, and
the depression part is inserted into and fitted to a part of a capacitor unit cell different from the capacitor unit cell.

3. The capacitor unit cell according to claim 1, wherein the protrusion part and the depression part have a shape of a pillar.

4. The capacitor unit cell according to claim 1, wherein the outer case includes an upper side, a lower side opposite to the upper side and first to fourth sides coupling the upper side and the lower side,
the first side is opposite to the third side,
the second side is opposite to the fourth side,
the protrusion part is provided on the first and third sides, and
the depression part is provided on the second and fourth sides.

5. The capacitor unit cell according to claim 1, wherein the protrusion part includes:
a structure perpendicularly protruded from one side of the outer case in one direction; and
an anti-releasing part protruded from the structure in a direction perpendicular to the one direction.

6. An energy storage module, comprising:
a plurality of capacitor unit cells each having a plus terminal and a minus terminal; and
a connection part configured to electrically connect the plus terminal of any one cell of the capacitor unit cells to the minus terminal of another cell;
wherein each of the capacitor unit cells includes an outer case housing an energy storage element, and
wherein the outer case includes:
a protrusion part protruded from one surface of the outer case; and
a depression part having a shape matched with the protrusion part and recessed from another surface of the outer case toward inside of the outer case.

7. The energy storage module according to claim 6, wherein the protrusion part of any one cell of the capacitor unit cells is inserted into the depression part of another cell adjacent to the any one cell, and
the protrusion part of the other cell adjacent to the any one cell is inserted into the depression part of the any one cell.

8. The energy storage module according to claim 6, wherein the protrusion part of any one cell of the capacitor unit cells is inserted into the depression part of another cell adjacent thereto, and
the protrusion part is slidably surface-contacted with and fitted to the depression part.

9. The energy storage module according to claim 6, wherein the protrusion part of any one cell of the capacitor unit cells is inserted into the depression part of another cell adjacent thereto, and
the protrusion part is fitted to the depression part by press fit.

10. The energy storage module according to claim 6, wherein the protrusion part and the depression part have a shape of a projection.

11. The energy storage module according to claim 6, wherein the outer case includes an upper side, a lower side opposite to the upper side, and first to fourth sides coupling the upper side and the lower side,
the first side is opposite to the third side,
the second side is opposite to the fourth side,
the protrusion part is provided to the first and third sides, and
the depression part is provided to the second and fourth sides.

12. The energy storage module according to claim 6, wherein the protrusion part includes:
a structure protruded from one side of the outer case in one direction; and
an anti-releasing part protruded from the structure in a direction perpendicular to the one direction.

13. The energy storage module according to claim 10, wherein the protrusion part further includes an anti-releasing groove having a shape matched with that of the anti-releasing part.
